(19) United States
(12) Patent Application Publication
(10) Pub. No.: US 2008/0087511 A1
(43) Pub. Date: Apr. 17, 2008

(54) Internal structure for landing bag shape control

(76) Inventors: Anthony P. Taylor, Huntington Beach, CA (US); Robert Sinclair, Costa Mesa, CA (US); John Sanders, Huntington Beach, CA (US); Kevin Sweeney, Irvine, CA (US)

Correspondence Address: JACOBSON HOLMAN PLLC, 400 SEVENTH STREET N.W., SUITE 600, WASHINGTON, DC, 20004, US

(21) Appl. No.: 11/580,998

(22) Filed: Oct. 16, 2006

(51) Int. Cl. F16F 9/04

(52) U.S. Cl. 188/266; 267/64.27; 267/113

(57) ABSTRACT

An impact attenuation bag has a height-reducing structure in the form of an internal rib that draws the upper and lower surfaces of the bag closer together, reducing the overall height of the bag when inflated as compared with the same bag in the absence of the rib. This gives the bag a flatter resting shape that provides significant performance enhancement by increasing the initial ground contact area and lowering the vehicle assembly center of gravity. As a result, the moment arm is reduced making the payload less likely to roll over. The rib may be a fabric sheet or cord laced in a criss-cross or other lacing pattern that extends from the top of the bag to the bottom.

### BACKGROUND OF THE INVENTION

1. Field of the Invention

The present invention is related to the field of landing bag force attenuation and, more particularly, to an internal structure to control the shape of impact attenuation bags.

2. Description of the Related Art

Impact attenuation bags are well known to those skilled in the art. Such airbags are used to attenuate impact forces on the payload upon landing and include an airbag having a control volume of compressible gas. As used herein, the term “airbag” is not limited to bags containing air but includes impact attenuating bags that contain other gases or gas combinations.

The shape of the control volume is determined by the naturally assumed inflated geometry of the airbag such that the bottom of the airbag tends to bulge. As a result, upon impact with the ground, the initial portion of the landing stroke is exhausted flattening the shape of the bag. During this time, the contact area between the ground and the airbag as well as the internal pressure increase slowly. Until the flattened shape is reached, the impact attenuating force is almost non-existent, dramatically reducing the stroke efficiency.

To accommodate the loss in stroke efficiency, airbag height may be increased which raises the effective center of gravity of the attenuation system. In landing scenarios with a horizontal velocity component, such as in a high-wind environment, the horizontal velocity of the vehicle during landing produces a rolling motion that must be arrested by the airbag to maintain stability. If the effective landing center of gravity is raised because of an increase in airbag height to accommodate stroke efficiency loss, however, the increased moment arm results in the pitching motion becoming substantially more pronounced such that the attenuation system may not be able to maintain vehicle stability. This can result in vehicle/payload roll-over and potentially damaging ground contact.

### SUMMARY OF THE INVENTION

In order to increase landing stroke efficiency and reduce payload rollover in an impact attenuation bag, the present invention provides a landing bag with an internal structure that gives the bag a flatter resting shape as compared with such bag without an internal structure. The internal structure includes one or more height-reducing elements, such as fabric panels or ribs, internal cords in a parallel or criss-cross lacing pattern, or internal straps or webbing, or a combination of the foregoing. The height-reducing elements extend from the upper interior surface of the landing bag to the lower interior surface and, by drawing the upper and lower surfaces closer together, reduce the overall height of the bag as compared with the same bag in the absence of such elements. The flatter shape provides significant performance enhancement by increasing the initial ground contact area and lowering the effective center of gravity of the vehicle/airbag assembly. As a result, the moment arm is reduced such that the payload is less likely to roll over upon impact. In addition, pressure and associated impact-attenuating forces build quickly to provide a faster, more efficient landing stroke.

Accordingly, it is an object of the present invention to provide an impact attenuation bag having an internal structure which controls the shape of the bag.

Another object of the present invention is to provide an internal structure for an impact attenuation bag in accordance with the preceding object that flattens the at-rest shape of the landing bag to increase landing stroke efficiency and prevent rollover in landing scenarios having a significant horizontal velocity component.

A further object of the present invention is to provide an impact attenuation bag having an internal structure that reduces the height requirement of the bag to lower the effective center of gravity of the assembly so as to reduce rollover moment.

Yet another object of the present invention is to provide an impact attenuation bag with an internal structure that develops landing bag forces early and rapidly.

A still further object of the present invention is to provide an impact attenuation bag with an internal structure in accordance with the preceding objects which can be readily manufactured, be of simple construction and easy to use so as to provide an impact attenuation bag that will be economically feasible and relatively trouble-free in operation.

These together with other objects and advantages which will become subsequently apparent reside in the details of construction and operation as more fully hereinafter described and claimed, reference being had to the accompanying drawings forming a part hereof, wherein like numerals refer to like parts throughout. While the drawings are intended to illustrate the invention, they are not necessarily to scale.

### BRIEF DESCRIPTION OF THE DRAWINGS

FIG. 1 is a perspective view of a conventional landing bag without an internal structure.

FIG. 2 is a side view of the conventional landing bag of FIG. 1.

FIG. 3 is a perspective view of a landing bag with an internal structure in accordance with the present invention.

FIG. 4 is a side view of the landing bag of FIG. 3.

FIG. 5 is a perspective of another landing bag with an internal fabric rib structure in accordance with the present invention.

FIG. 6 is a partially transparent view of the landing bag with internal fabric rib structure of FIG. 5.

FIG. 7 is a cross-sectional view of a landing bag with a fabric rib internal structure in accordance with the present invention.

FIG. 8 is a cross-sectional view of a landing bag with another fabric rib internal structure in which the rib has a fillet in accordance with the present invention.

FIG. 9 is a cross-sectional view of a landing bag wall with attachment flaps and reinforcing layer adhered thereto, the attachment flaps forming an attachment strip in accordance with the present invention.

FIG. 10 is a perspective of yet another landing bag with a laced cord rib for shape control in accordance with the present invention.

FIG. 11 is a partially transparent view of the landing bag with laced cord rib of FIG. 10.

FIG. 12 is a cross-sectional view of a landing bag with a parallel cord rib internal structure in accordance with the present invention.

FIG. 13 shows the landing bag wall and attachment strip of FIG. 9.

FIG. 14 illustrates a lacing pattern joining two attachment strips of the type shown in FIG. 13.

FIG. 15 illustrates stress contours associated with the laced cord rib internal structure of FIG. 11.

FIG. 16 illustrates stress contours associated with the fabric rib internal structure of FIG. 7.

FIGS. 17A, 17B and 17C depict three airbag landing stages: upon impact, after 10 ms and after 20 ms, respectively, for a conventional landing bag.

FIGS. 18A, 18B and 18C depict three airbag landing stages: upon impact, after 10 ms and after 20 ms, respectively, for a ribbed landing bag in accordance with the present invention.

FIG. 19 is a graph based on a simulation comparing the airbag landing time history of a conventional landing bag with that of a ribbed landing bag in accordance with the present invention.

FIG. 20 is a graph comparing the airbag landing stroke efficiency of a conventional landing bag with that of a ribbed landing bag in accordance with the present invention.

FIG. 21 is a graph comparing the horizontal velocity vehicle rotation time history for a 30 ft/sec landing scenario of a conventional landing bag with that of a ribbed landing bag in accordance with the present invention.

### DETAILED DESCRIPTION OF THE PREFERRED EMBODIMENTS

In describing preferred embodiments of the invention illustrated in the drawings, specific terminology will be resorted to for the sake of clarity. However, the invention is not intended to be limited to the specific terms so selected, and it is to be understood that each specific term includes all technical equivalents which operate in a similar manner to accomplish a similar purpose.

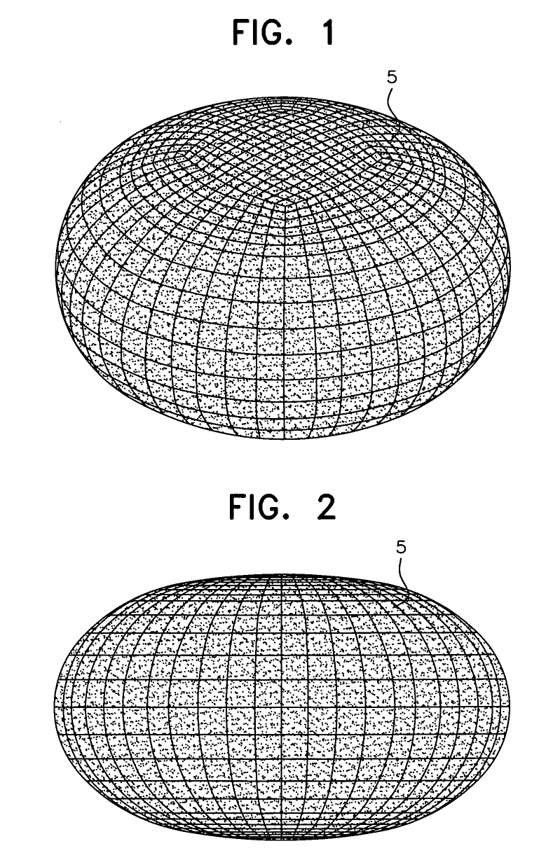

As representatively shown in FIGS. 1 and 2, conventional landing bags 5 adopt a naturally assumed inflated geometry when filled with a control volume of compressible gas, such as air or the like. This often results in a height and a footprint area prior to impact that are not ideal, particularly for landing scenarios with a horizontal velocity component, such as in a high wind environment. In such an environment, the moment produced by the product of the bag contact area, the bag internal pressure, the friction coefficient and the distance to the assembly center of gravity, or moment arm, acts to turn the vehicle or other payload over. Accordingly, the present invention is directed to reducing the moment arm in order to enhance landing stability and prevent payload rollover.

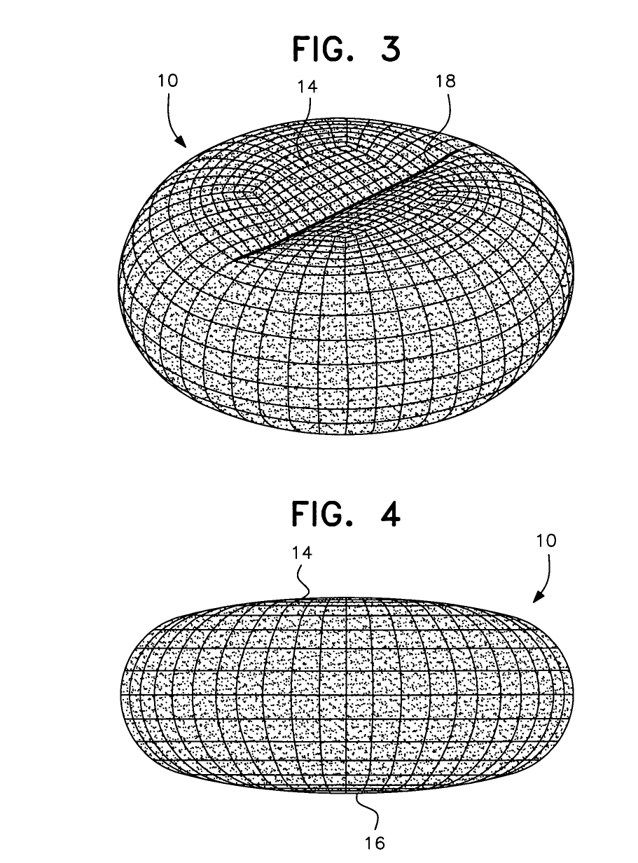

FIGS. 3 and 4 are perspective and side views, respectively, of a landing bag generally designated by the reference numeral 10, with an internal height-reducing structure generally designated by the reference numeral 12 (see FIG. 6), in accordance with the present invention. The landing bag 10 generally corresponds with the landing bag 5 in FIGS. 1 and 2 in terms of size and style so that a comparison can be made between the respective heights and footprints of the two landing bags.

The landing bags described herein are suitable for landing impact attenuation of payloads including vehicles such as Unmanned Aerial Vehicles (UAVs), unmanned spacecraft, manned spacecraft, etc. Such landing bags are typically made of a polyurethane-coated fabric material. Silicon may also be used to coat the landing bag fabric.

As can be seen through a comparison of FIGS. 2 and 4, the height of the landing bag 10 with the internal structure 12 is reduced as compared with the height of conventional landing bag 5. In addition, the footprint of landing bag 10 is increased relative to the footprint of landing bag 5. Both the reduced height and the increased footprint are the result of the internal height-reducing structure 12 that draws the upper surface 14 of the bag and the lower surface 16 of the bag 10 together. The height-reducing structure 12 produces an attachment line 18 that is visible on the upper and lower surfaces but is otherwise contained within the bag.

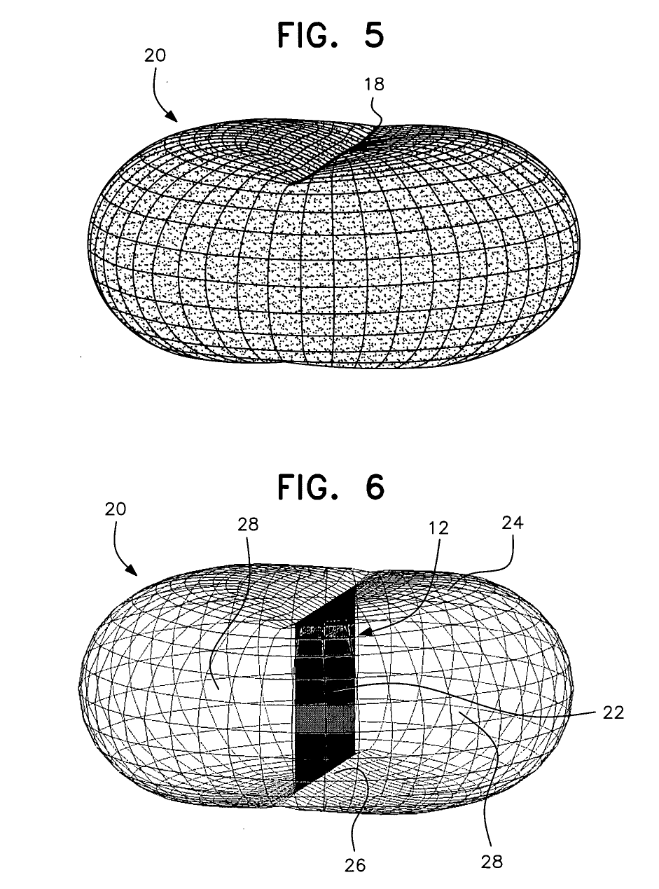

An oblong-shaped landing bag, generally designated by the reference numeral 20, is shown in FIGS. 5 and 6. According to this embodiment of the present invention, the height-reducing structure 12 is embodied as a fabric rib 22. The fabric rib 22 is attached to the inside upper surface 24 and to the inside lower surface 26 of the bag interior region 28. With the oblong-shaped bag 20, the rib 22 is attached so as to be transverse to a longitudinal length of the bag while generally bisecting the interior region 28 into two halves. In the oval bag shape shown by landing bag 10 in FIGS. 3 and 4, however, the height-reducing structure 12, if in the form of a fabric rib 22, can be oriented in any direction as the lateral and longitudinal dimensions of landing bag 10 are equal.

For ease of reference herein, any landing bag having an internal height-reducing structure in accordance with the present invention is generically referred to as a “ribbed landing bag”.

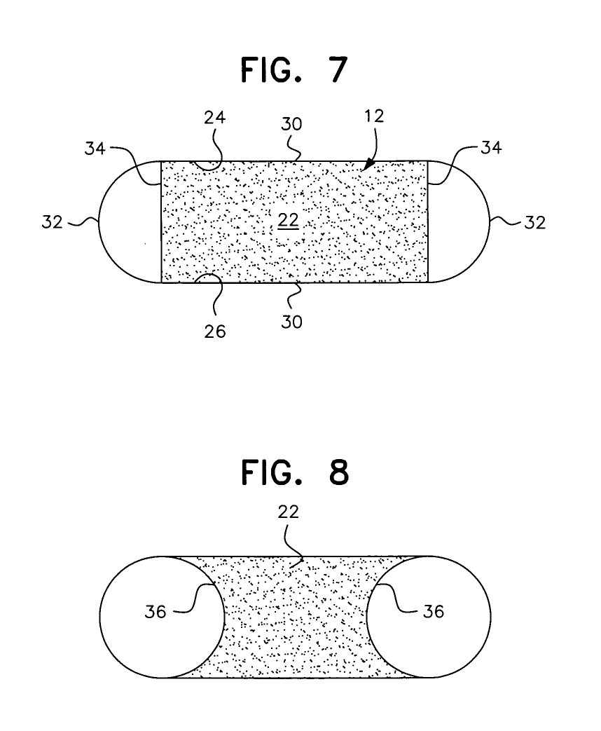

As shown in the sectional view of FIG. 7, the inward pull of the rib 22 produces a generally flat portion 30 along both the upper and lower surfaces 24, 26 of the bag 20. The flat portions 30 are joined by the curved side portions 32. The sides 34 of the rib 22 can be generally perpendicular to the flat portions 30, as shown in FIG. 7, or the rib 22 can be provided with a fillet 36 as shown in FIG. 8.

The fillet 36 reduces the point load at the edges of the rib. This is advantageous in that the polyurethane-coated fabric material used in a preferred landing bag has a relatively high modulus of elasticity and, accordingly, is much less forgiving in terms of manufacturing variability to maintain consistent load distributions. More particularly, these materials have a very low elongation to failure and thus are quite sensitive to point loading. The addition of internal ribs further exacerbates the loading issues as the ends of the ribs create point loads. The curvature of the fillet reduces this edge loading, as does the manner in which the rib is attached to the airbag as is discussed hereinafter.

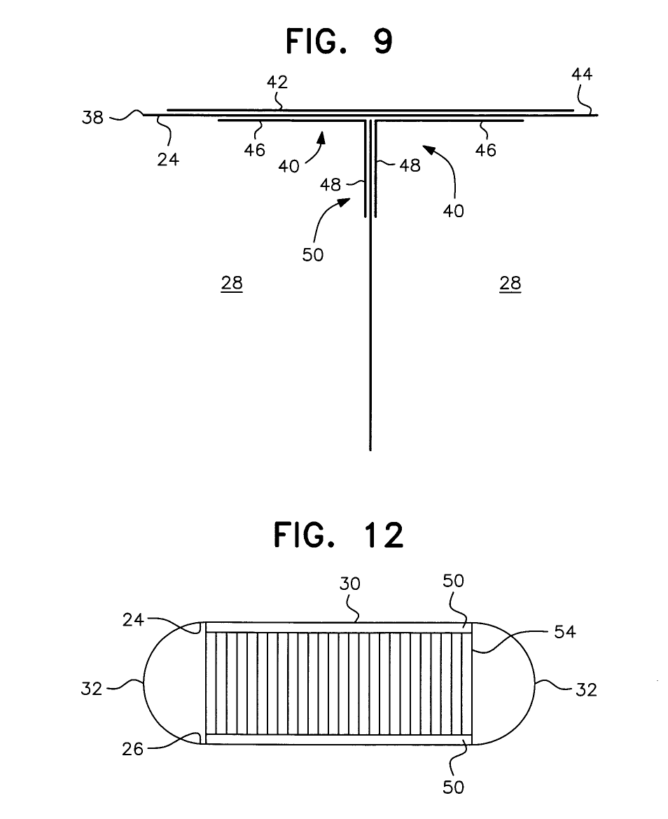

As shown in FIG. 9, the rib 22 is secured to each of the upper and lower inside surfaces 24, 26 of the bag wall 38 by means of a pair of attachment flaps generally designated by the reference numeral 40 and a reinforcing layer 42. The attachment flaps 40 and reinforcing layer 42 are generally made of the same material as that of the landing bag.

With particular reference to connection of the rib 22 to the upper inside surface 24 of the bag 20, first and second attachment flaps 40 are positioned in the interior region 28 of the bag 20 and a reinforcing layer 42 is positioned on the outer surface 44 of the bag opposite the flaps 40. Each attachment flap 40 has a bag contacting portion 46 and a rib contacting portion 48. The bag contacting portions 46 of the two flaps are positioned adjacent one another so as to bring their respective rib contacting portions 48 into abutment with one another. The abutting rib contacting portions 48 are generally perpendicular to the bag contacting portions 46 and form an attachment strip generally designated by the reference numeral 50 for the rib 22. The bag contacting portions 46 are secured to the upper inside surface 24 of the airbag wall 38 while the reinforcing layer 42 is placed on the upper exterior surface 44 opposite the bag contacting portions 46. The bag wall 38 is thereby sandwiched between the bag contacting portions 46 of the flaps 40 and the reinforcing layer 42.

The attachment flaps 40 are preferably affixed to the airbag wall 38 through a combination of a stitching pattern and thereafter a weld. The stitching pattern is preferably a large zig-zap pattern that further improves load bearing capacity and mitigates the risk of peel failure. Because the stitching can create a leak path out of the airbag, an additional welded layer of fabric may be placed over the stitching to provide an interior gas barrier lining. In forming the weld, heat and pressure are applied to the joint between the wall 38 and the flap 40 until the polyurethane coating on the two fabric articles fuses. A similar welded joint is formed concurrently on the inside between the wall 38 and the reinforcing layer 42.

A comparable construction is undertaken on the lower inside surface 26 of the bag 20, with the abutting rib contacting portions of the second pair of flaps (not shown) forming a second rib attachment strip like the first. The rib 22 is then inserted between the respective abutting rib contacting portions 48, and attached between the two attachment strips 50 to bisect the bag interior 28.

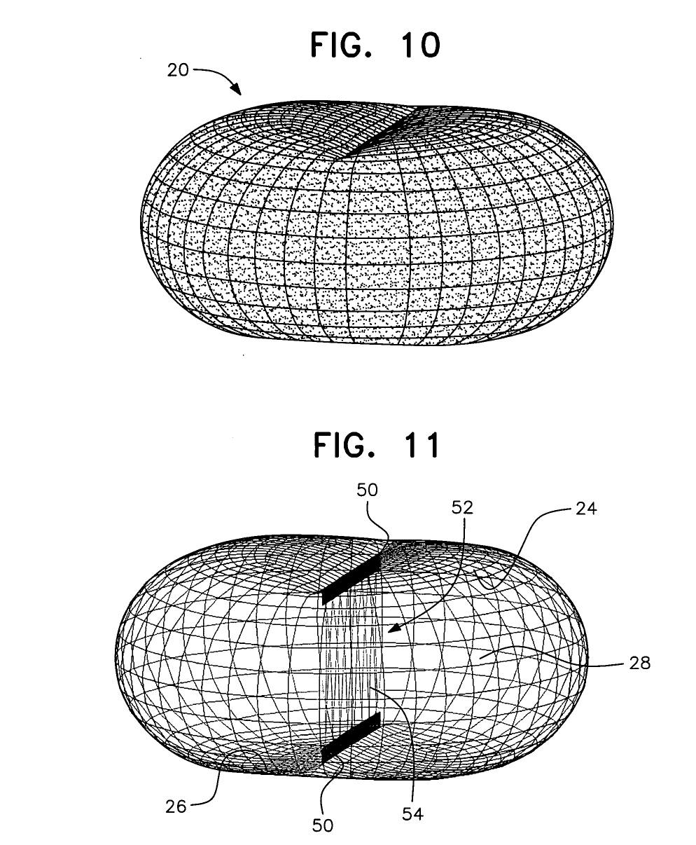

According to a further preferred embodiment of the internal structure, the height-reducing structure 12 is embodied as a laced cord rib generally designated by the reference numeral 52 as shown in FIGS. 10 and 11. The cord 54 is attached to attachment strips 50 along the inside upper surface 24 and the inside lower surface 26 of the bag 20 and extends across the interior region 28. The cord 54 is preferably laced in a criss-crossing pattern to form a plane defined by the plurality of interlaced lines. The lacing configuration distributes the load across the entire rib as compared with the fabric rib in which the load paths are maintained primarily along the edges of the fabric assembly. Hence, the laced rib reduces loading at the edge of the attachment flaps.

Like the embodiment with the fabric rib, with an oblong bag 20 as shown, the plane of the cord rib 52 is transverse to the longitudinal length of the bag to generally bisect the interior region 28 into two halves. In the oval bag shape shown in FIGS. 3 and 4, the height-reducing structure, if in the form of a laced cord rib 52, can be oriented in any direction as the lateral and longitudinal dimensions of the bag 10 are equal.

In the embodiment shown in FIG. 12, the cord 54 is laced so as to run in parallel lines originating from respective attachment points positioned along the attachment strip 50. As shown, the inward pull of the cord 54, like that of the fabric rib 22, produces a generally flat portion 30 along both the upper and lower surfaces 24, 26 of the bag. The flat portions 30 are joined by the semi-circular side portions 32.

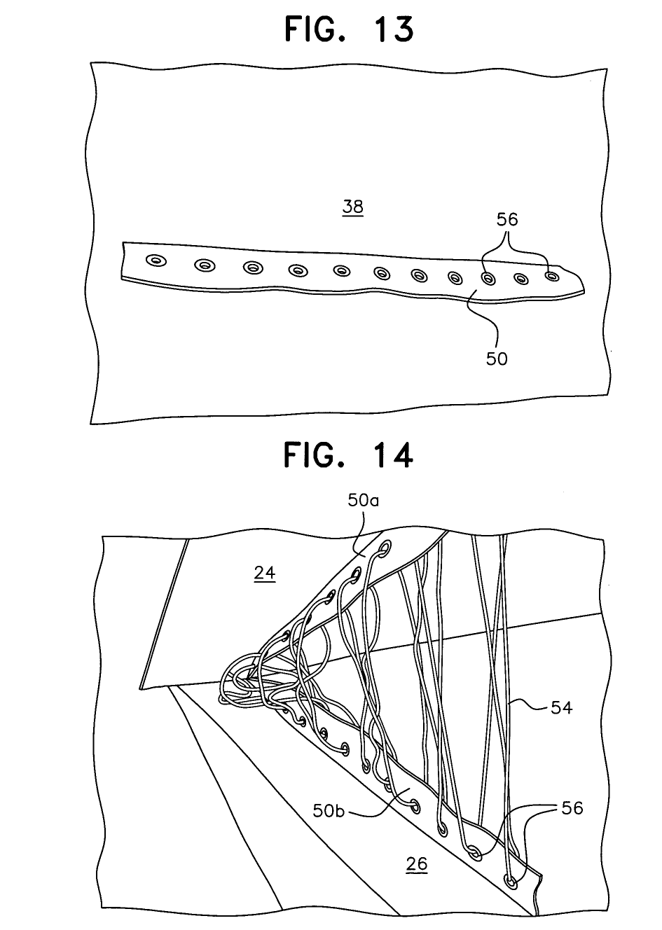

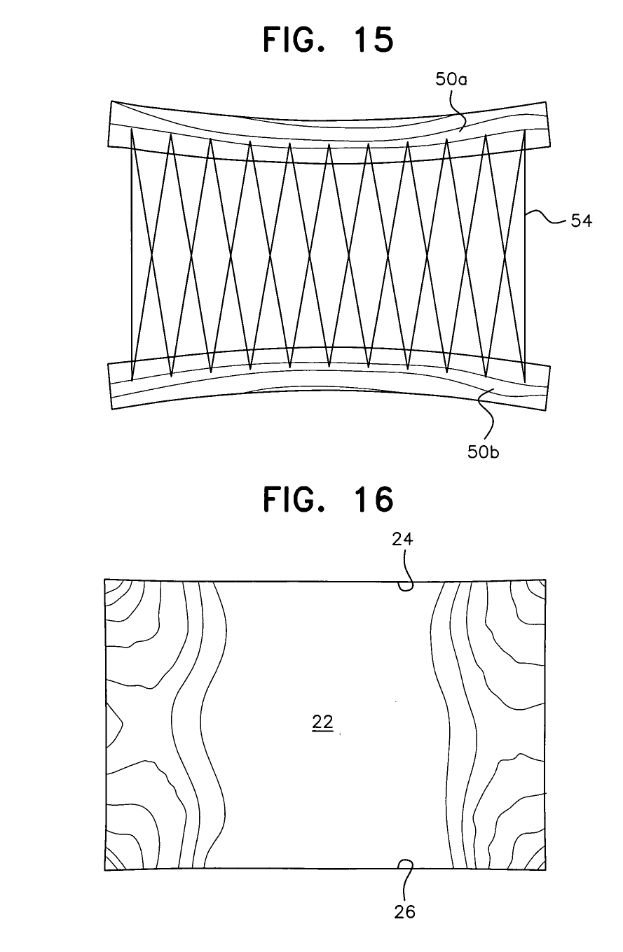

In both lacing arrangements, criss-cross and parallel, the cord 54 is directed through a plurality of attachment points provided along the attachment strip 50 that allow the cord 54 to slide. These attachment points may be embodied as a plurality of grommets 56 as shown in FIG. 13. The cord 54 is passed through the grommets 56, alternating from the attachment strip 50a on the upper inside surface 24 of the bag to the attachment strip 50b on the lower inside surface 26 of the bag in a continuous back-and-forth style as when lacing a shoe, as shown in FIG. 14. The lacing pattern thus extends across the interior region 28 of the landing bag 20 from top to bottom in either a criss-cross pattern as shown in FIGS. 11 and 15 or a parallel line pattern as shown in FIG. 12. Other lacing pattern options could, of course, be employed to accommodate various load distribution requirements. For example, multiple cords may be used, each having a limited number of attachment points.

The grommets 56 provide a low friction surface for the cord to minimize cord abrasion. The distribution of the grommets along the attachment strips can be varied to optimize efficient load distribution. For example, the grommets may be placed closer together if greater cord density is needed. Interchangeability of cord type and/or strength is also facilitated by the grommet design. The cord is preferably made of Spectra, a material that is light in weight and relatively strong, with a “slick” surface that facilitates smooth interfacing with the grommets. Spectra also has low elongation properties such that the laced cord rib maintains the desired design shape. Other cord materials that can be used include Vectran, Kevlar and nylon, as well as other materials that demonstrate low elongation, low friction, high tenacity and efficient joints, i.e., joints that are capable of maintaining joint strength when two adjacent strands are attached to one another.

The use of a single continuous length of cord evenly distributes inflation load across the rib, and also reduces the time required for installation and refurbishment as compared with alternate lacing patterns using multiple cords. More significantly, the laced ribs as a whole provide improved airbag venting performance as compared with the solid fabric rib embodiment.

FIG. 15 depicts the laced cord rib stress contours on the upper and lower surfaces of the bag which, as shown, are even on the top and the bottom. Comparable fabric rib stress contours including the point loads are set forth in FIG. 16. The high stress exhibited by the corners makes the fabric rib design more susceptible to peel failure.

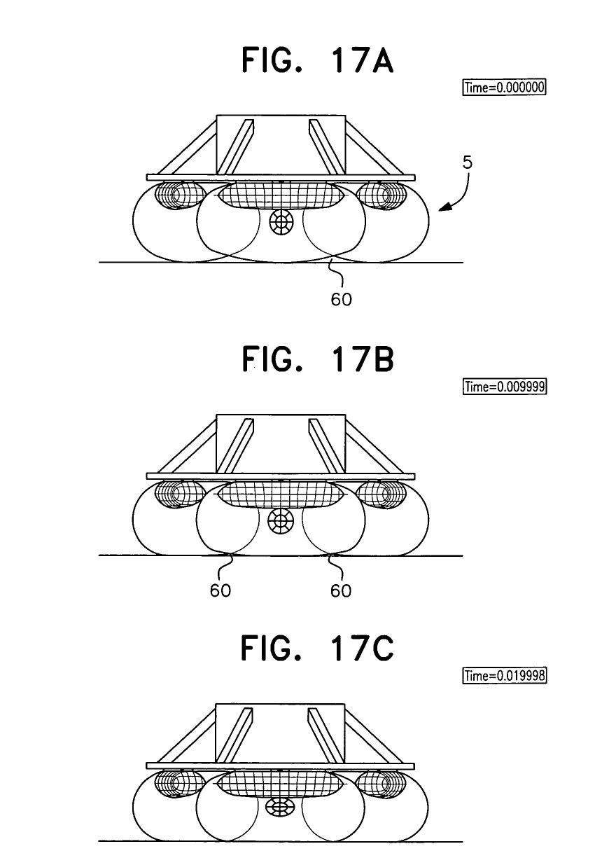

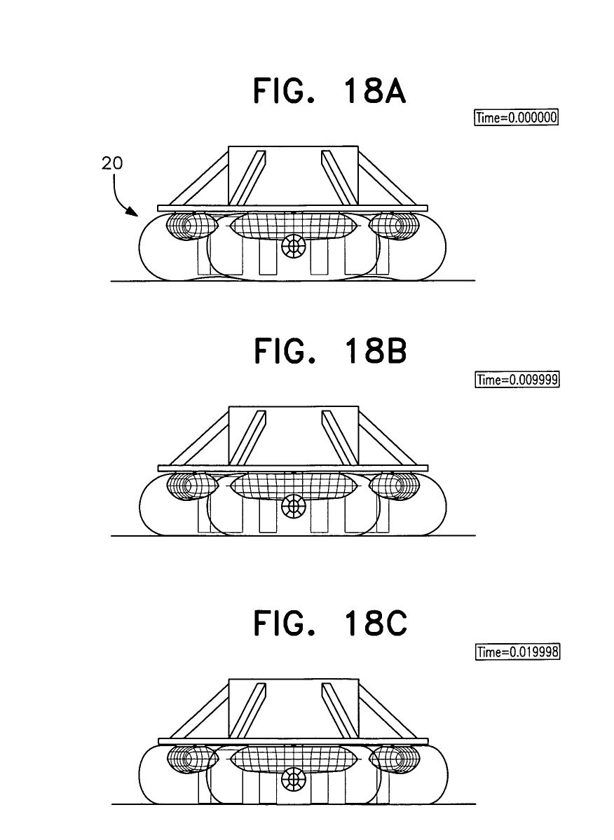

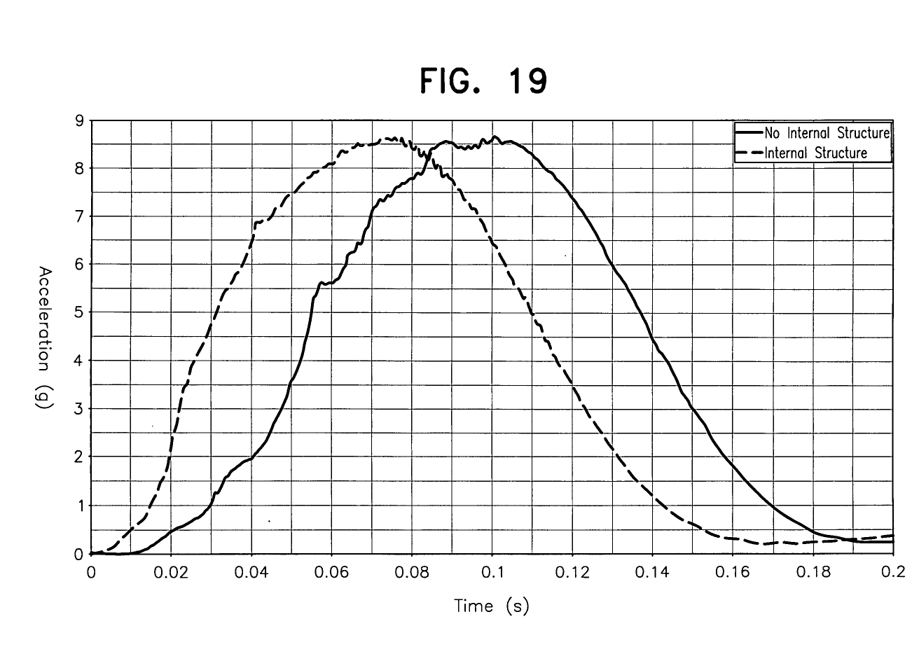

Whether equipped with the fabric rib 22 or the laced cord rib 52, the ribbed landing bag according to the present invention demonstrates improved performance relative to conventional landing bags. As comparatively set forth for the conventional landing bag assembly of FIGS. 17A, 17B and 17C versus the ribbed landing bag as set forth in FIGS. 18A, 18B and 18C, the internal structure within the ribbed landing bag reduces the landing stroke loss that occurs with the conventional bag. This increases overall “stroke efficiency” which is defined as the integral of the airbag force versus displacement as compared to a square pulse of the same overall displacement having a height at the peak airbag force.

FIGS. 17A and 18A provide a comparison at the moment of initial ground contact in which it is clear that the conventional bag in FIG. 17A has a greater height and a smaller footprint than does the ribbed landing bag of FIG. 18A. During the first 10 ms following ground contact, the ribbed landing bag has come into full contact with the ground, as shown in FIG. 18B, and has already begun to absorb landing forces from the payload. With the conventional bag shown in FIG. 17B, by contrast, no appreciable force has accumulated between the airbag and the vehicle; instead, the bag is still in the process of flattening, with ground contact gaps 60 remaining and the bag height still being greater than when the bag is fully flattened. A simulation of this comparative performance is shown graphically in FIG. 19 which depicts the delayed response of a system without ribs.

After 20 ms, the conventional bag is just beginning to attenuate the impact forces as shown in FIG. 17C. The ribbed landing bag shown in FIG. 18C, on the other hand, has already built impact-attenuating forces which results in a fast, efficient landing stroke.

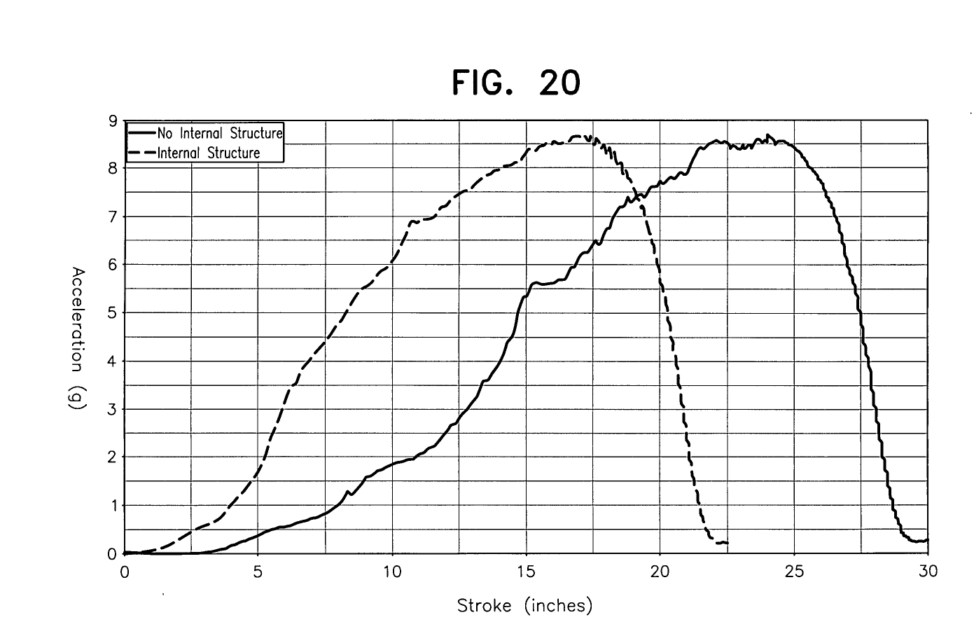

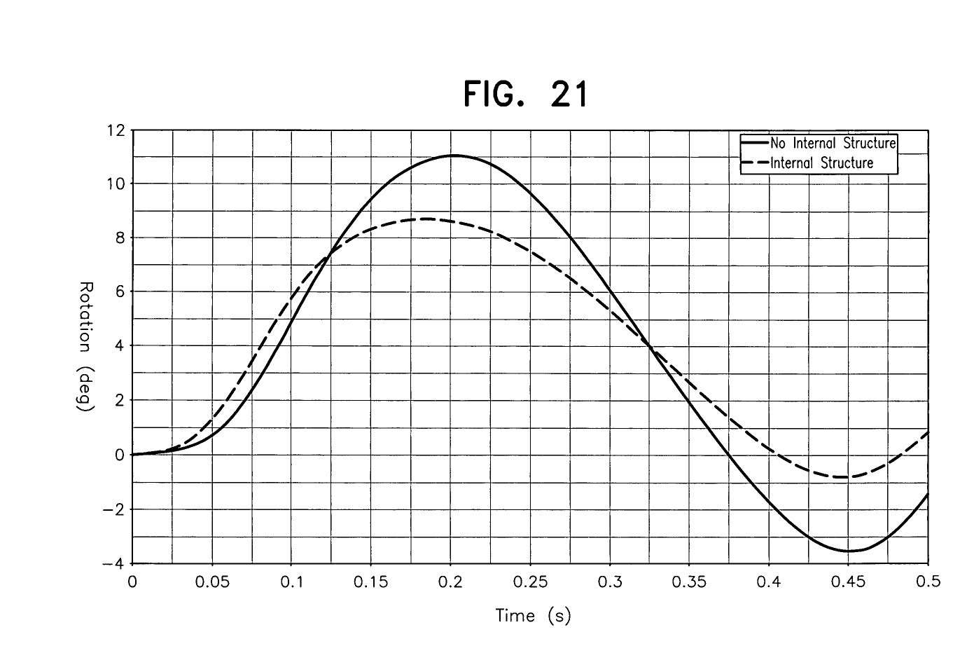

A comparative graph showing the improvement in airbag landing stroke efficiency demonstrated by the ribbed landing bag of FIGS. 18A-18C as compared with the conventional bag of FIGS. 17A-17C, is set forth in FIG. 20. For a given peak acceleration specification, this improvement in efficiency reduces the airbag height requirement, lowering the effective center of gravity of the system. As noted at the outset, lowering the effective center of gravity of the assembly is advantageous in landing scenarios having a horizontal velocity component because the rolling motion that is produced by such component is thereby reduced. For example, in a 30 ft/sec landing scenario such as that represented by the graph of FIG. 21, a conventional bag without an internal structure has an approximately 25% greater rolling motion or rotation than does the ribbed landing bag according to the present invention.

The foregoing descriptions and drawings should be considered as illustrative only of the principles of the invention. The invention may be configured in a variety of shapes and sizes and is not limited by the preferred embodiments. For example, in many cases it may be desirable to include two or more substantially parallel ribs within the same airbag; this is illustrated by the impact attenuation bag shown in FIGS. 18A-18C which has three semi-parallel ribs. In multiple rib embodiments, each rib can have a different height or all ribs can have the same height, etc., according to specific configuration requirements. It is also foreseen that two ribs can be oriented to intersect with and be substantially perpendicular to one another, a configuration that would be particularly well-suited to a generally oval landing bag in which the two ribs could be centered.

Numerous applications of the present invention will readily occur to those skilled in the art. Therefore, it is not desired to limit the invention to the specific examples disclosed or the exact construction and operation shown and described. Rather, all suitable modifications and equivalents may be resorted to, falling within the scope of the invention.

What is claimed is:

1. An impact attenuation bag comprising:
an airbag having an upper surface and a lower surface; and
a height-reducing structure extending between and connected to said upper and lower surfaces across an internal region of said bag, said height-reducing structure having a vertical dimension that is less than a distance between said upper and lower surfaces in an absence of said height-reducing structure such that said attenuation bag when inflated is flattened by said height-reducing structure.

2. The impact attenuation bag as set forth in claim 1 wherein said height-reducing structure includes a laced cord rib.

3. The impact attenuation bag as set forth in claim 2, further comprising:
an attachment strip affixed to an inner surface of said upper and lower surfaces, each attachment strip having two attachment flaps with a bag contacting portion and a rib contacting portion, said laced cord rib being secured to said rib contacting portions of said attachment strips; and
a reinforcing layer affixed to an exterior surface of each of said upper and lower surfaces in respective areas overlying said bag contacting portions.

4. The impact attenuation bag as set forth in claim 3, said rib contacting portions are in abutment with one another with a plurality of grommets secured through said abutting rib contacting portions.

5. The impact attenuation bag as set forth in claim 4, wherein said cord rib includes a cord laced through said grommets to run back and forth between the attachment strips on the inner surfaces of the upper and lower surfaces.

6. The impact attenuation bag as set forth in claim 5, wherein the cord rib is made of a single cord laced in a criss-cross pattern.

7. The impact attenuation bag as set forth in claim 1, wherein said height-reducing structure includes a fabric rib.

8. The impact attenuation bag as set forth in claim 7, further comprising an attachment strip affixed to said upper and lower inside surfaces, said fabric rib being secured to said attachment strips.

9. The impact attenuation bag as set forth in claim 8, wherein each attachment strip includes two attachment flaps each having a bag contacting portion and a rib contacting portion, said rib contacting portions being affixed to said interior surfaces and said rib contacting portions being in abutment with one another, said fabric rib being inserted and secured between said abutting rib contacting portions.

10. The impact attenuation bag as set forth in claim 9, further comprising a reinforcing layer affixed to an exterior surface of said bag in an area overlying said bag contacting portions.

11. The impact attenuation bag as set forth in claim 7, wherein said fabric rib had a fillet on each end.

12. An impact attenuation bag comprising an airbag, a height-reducing internal structure connected to upper and lower inside surfaces of said bag and extending between said surfaces across an internal region of said bag, and a compressible gas inflating said airbag such that said height-reducing structure limits inflation of said internal region to flatten said airbag.

13. The impact attenuation bag as set forth in claim 12, wherein said height-reducing structure includes a laced cord rib.

14. The impact attenuation bag as set forth in claim 13, further comprising an attachment strip affixed to said upper and lower inside surfaces, said laced cord rib being secured to said attachment strips.

15. The impact attenuation bag as set forth in claim 14, wherein each attachment strip includes two attachment flaps each having a bag contacting portion and a rib contacting portion, said rib contacting portions being affixed to said interior surfaces and said rib contacting portions being in abutment with one another.

16. The impact attenuation bag as set forth in claim 15 further comprising a reinforcing layer affixed to an exterior surface of said bag in an area overlying said bag contacting portions.

17. The impact attenuation bag as set forth in claim 15, wherein a plurality of grommets are secured through said rib contacting portions.

18. The impact attenuation bag as set forth in claim 17, wherein said cord rib includes a cord laced through said grommets back and forth between the attachment strips on the upper and lower inside surfaces.

19. The impact attenuation bag as set forth in claim 18, wherein the lacing of said cord is in a criss-cross pattern.

20. The impact attenuation bag as set forth in claim 12, further comprising attachment strips affixed to said upper and lower inside surfaces, respectively, said height-reducing structure including a fabric rib that is secured to said attachment strips.
